(19) United States
(12) Patent Application Publication
(10) Pub. No.: US 2003/0202842 A1
(43) Pub. Date: Oct. 30, 2003

(54) Ball-and-socket joint

(76) Inventor: Olaf Abels, Belm (DE)

Correspondence Address: McGlew and Tuttle, Scarborough Station, Scarborough, NY, 10510-0827, US

(21) Appl. No.: 10/333,238

(22) PCT Filed: May 14, 2002
(86) PCT No.: PCT/DE02/01734

(30) Foreign Application Priority Data
May 17, 2001 (DE) 101 24 295.6

(51) Int. Cl. F16D 1/12

(52) U.S. Cl. 403/134

(57) ABSTRACT

A ball-and-socket joint, preferably for vehicle suspensions or steering mechanisms of motor vehicles, with a joint housing, a pivot pin (1), which comprises a spherical surface (3) and a pin part (2) and is mounted with the spherical surface rotatably and deflectably in the joint housing (5) and is fixed with the pin part (2) on a mount (7) provided on the chassis, and with an elastic sealing bellows (8), which is fixed statically at the joint housing (5) and by means of at least one sealing seat at the pin part (2), is presented, in which the sealing seat has according to the present invention an elastic sealing ring (11) that is directly in contact with the pin part (2) under pretension or is connected to same in substance between the sealing bellows (8) and the pin part (2) and an annular sleeve (13) arranged between the sealing bellows (8) and the sealing ring (11). Optimal coordination of the sealing components (annular sleeve and sealing ring) that perform relative movements in relation to one another can be achieved due to the design according to the present invention, so that corrosion problems known from the state of the art are eliminated at the partition line of the seal.

### SPECIFICATION

The present invention pertains to a ball-and-socket joint, preferably for vehicle suspensions and steering mechanisms of motor vehicles, with a joint housing, a bearing journal, which comprises a spherical surface and a pin part and is mounted with the spherical surface rotatably and deflectably in the joint housing and is fixed with the pin part on a mount provided on the chassis, and with an elastic sealing bellows, which is fixed statically on the joint housing and on the pin part by means of at least one sealing seat.

A very great variety of embodiments of ball-and-socket joints of the type of the class described have been known from the state of the art. Since a relative movement takes place in such ball-and-socket joints between the housing and the bearing journal, the sealing of the bearing pair comprising the spherical surface of the bearing journal and a corresponding bushing must be dynamic. In prior-art solutions, the sealing bellows is therefore seated directly on the jacket surface of the pin part of the bearing journal with a thickened bead part provided at its end, which forms an inner sealing seat, and it is optionally held there by an internal material stress or by the tension of a lock washer attached on the outside. The general problem of such an embodiment is the tendency of the pin surface to corrode, because the pin is usually made of metal, and the surface of the sealing seat tends to undergo changes after a certain operating time despite a coating that is present for corrosion prevention, which ultimately leads to the failure of the sealing system and subsequently of the entire ball-and-socket joint due to the penetration of contaminants as a consequence of the defective sealing seat.

The object of the present invention is therefore to bring about an improved service life of the sealing seat in the area of the sealing seat between the pin part and the sealing bellows of the ball-and-socket joint and thus to prolong the overall service life of the ball-and-socket joint in question.

This object is accomplished in conjunction with the class-forming features by the technical teaching disclosed in the characterizing part of claim 1.

According to this teaching, the sealing seat between the sealing bellows and the pin part has, directly at the pin part, an elastic sealing ring that is in contact under pretension and an annular sleeve arranged between the sealing bellows and the sealing ring. Due to this design according to the present invention, the sliding sealing seat between the sealing bellows and the adjacent pin part of the bearing journal is displaced from the direct surface of the pin part into the partition line between the sealing ring and the adjacent annular sleeve.

The additional partition lines located directly between the pin part and the sealing ring as well as those between the annular sleeve and the sealing bellows are so-called static partition lines, at which no relative movements take place between the adjacent components, so that the corrosion problems described are ruled out here to a very great extent. The displacement of the critical partition lines into the area between the sealing ring and the annular sleeve makes it possible to select many different material pairs, which can be optimally coordinated in their combination with respect to the prevention of corrosion damage and the improvement of the tribological properties. Moreover, the advantage arises that long-lasting lubrication of the partition line with suitable greases is possible more easily due to the sharper separation of the sealing joint from the interior space of the bellows and the environment.

Special other embodiments of the subject of the present invention additionally appear from the features of the subclaims. Concerning the selection of the materials, it proved to be particularly advantageous to make the sealing ring from an unvulcanized rubber material or a plastic, preferably PUR or PFTE. The cross section of the non-installed sealing ring may be circular or oval, and, in particular, the circular cross section can be considered to be favorable in terms of the manufacturing costs because of the commercially available standard parts. Additives that favorably affect the sliding ability may be added to the unvulcanized rubber or plastic material used.

The sealing ring is usually pushed over the pin by elastically widening it during the assembly of the ball-and-socket joint, and the pretension predetermined by the material selected and the dimensions guarantees the statically firm seating of the sealing ring on the pin part. Moreover, it is also conceivable, however, to vulcanize the sealing ring on the pin part in a special operation and thus to establish a rigid connection between the bearing journal and the sealing ring.

It proved to be advantageous concerning the design of the annular sleeve to make this from special steel or plastic. To improve the corrosion protection and the tribological properties, the surface of the annular sleeve facing the sealing may, moreover, have an anticorrosion coating and/or a sliding-improving coating.

The sealing seat comprises essentially the sealing ring with static contact with the pin part and the annular sleeve, which is in turn statically firmly in contact with the sealing bellows, i.e., it is also rigidly connected to the sealing bellows. It is correspondingly also conceivable to make the annular sleeve and the sealing bellows in one piece in order to improve the qualitative properties of the partition line located between the adjacent component [sic—components?—Tr.Ed.], similarly to the rigid connection between the pin part and the sealing ring.

Moreover, it proved to be advantageous, especially in the case of larger sealing ring cross sections and especially in the case of rectangular cross sections, to provide additional stiffened areas from a nonelastic material, preferably metal.

Various exemplary embodiments of the subject of the present invention will be explained in greater detail below on the basis of the drawings attached. In the drawings,

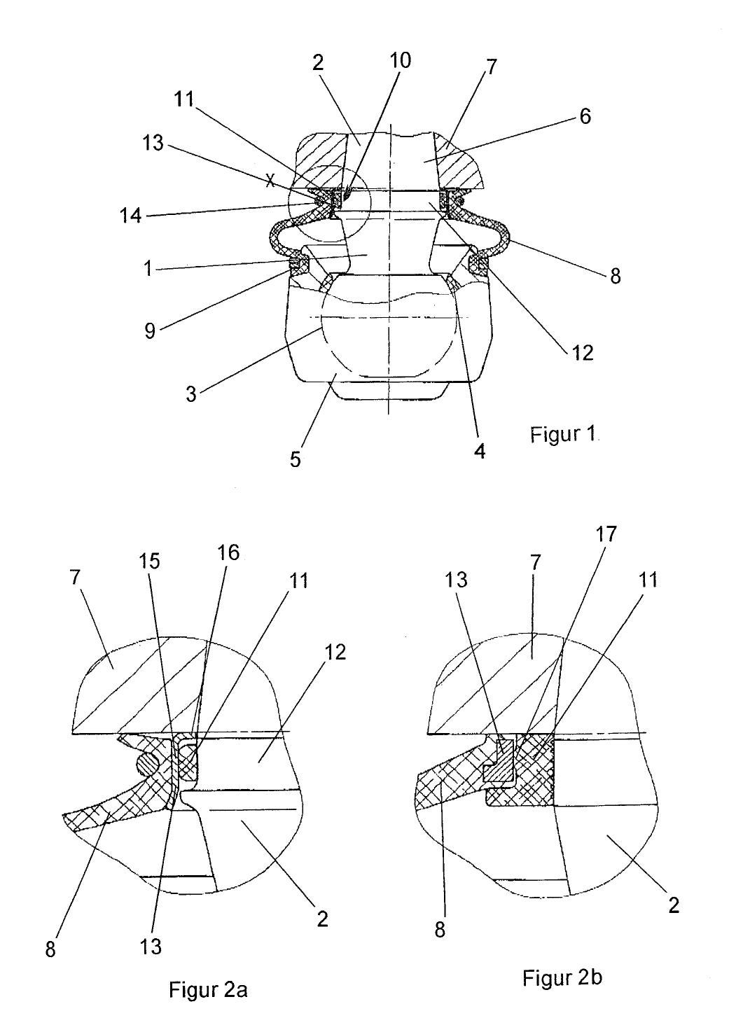

FIG. 1 shows a partial sectional view in the area of the bellows of a ball-and-socket joint according to the present invention, and

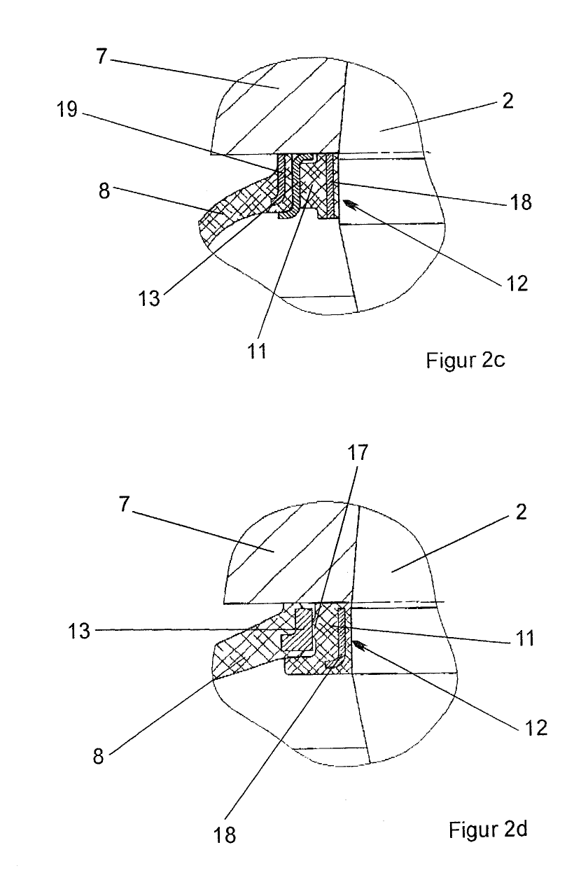

FIGS. 2a-2d show different embodiments corresponding to detail X in FIG. 1.

In the ball-and-socket joint according to the present invention shown in FIG. 1, a pivot pin 1, which comprises a pin part 2 and a spherical surface 3 made in one piece with it, is mounted in the joint housing 5 of the ball-and-socket joint by means of a joint shell 4 made of a material of limited elasticity. The pin part 2 of the pivot pin 1 has a conical area 6, which is used to fasten the pivot pin 1 within a vehicle part 7.

An elastic sealing bellows 8, one end of which is statically fastened in a circular groove on the circumference of the joint housing 5 by means of a lock washer 9, is used for sealing between the joint housing 5 and the pivot pin 1. The other end of the sealing bellows 8 is provided with a sealing seat 10, which is used for tightly joining the sealing bellows 8 with the pin part 2. Compared with conventional designs, this sealing seat has a multipart design and has, directly adjoining the pin part 2, an elastic sealing ring 11 that is in contact with the pin part 2 under pretension. The sealing ring 11 is widened during the assembly of the ball-and-socket joint and is pushed over the free end of the pin part 2 up to the shoulder 12, where it will be statically firmly seated because of its elastic properties after the conclusion of the assembly operation. An annular sleeve 13 is arranged on the outer circumference of the sealing ring 11 between the sealing ring and the sealing bellows 8. The sealing bellows 8 and the annular sleeve 13 are firmly connected to one another by means of a lock washer 14 in the embodiments shown in FIGS. 1 and 2a. A relative movement within the sealing seat 10, which arises because of a rotation or pivoting of the pivot pin 1 with its spherical surface 3 within the joint shell 4, thus takes place in the partition line between the sealing ring 11 and the adjacent inner surface of the annular sleeve 13.

Since a relative movement between components that mutually seal one another may lead to corrosion-related failure of the sealing effect in a short time under unfavorable general conditions, the displacement of the critical partition line and the possibility of optimally coordinating the mutually adjacent components responsible for the sealing effect for their particular field of use in terms of their material properties create an improved possibility of guaranteeing the sealing effect of the sealing seat between the pin part 2 and the sealing bellows 8 over a long period of time. Moreover, the sliding properties between the components moving in relation to one another can be optimized by the selection of the material for the sealing ring 11 and the annular sleeve 13.

For example, unvulcanized rubber materials of a higher Shore hardness and, as an alternative, rubber materials such as NBR, HNBR or EPDM may be used as materials for the sealing ring 10; moreover, the sealing rings may be made of plastics such as PUR or modified PFTE. The materials mentioned may, of course, be provided with additives to improve the sliding ability. In addition, the surface of the sealing ring may, of course, be provided with suitable coatings.

FIG. 2a shows once again the design of the sealing seat 10 corresponding to detail X in FIG. 1 in an enlarged detail. This figure shows that the cross section of the annular sleeve 13 has a first partial area 15 extending in parallel to the surface of the pin part and a second partial area 16, which is bent in relation thereto. The angle between the two partial areas is approx. 90° in the example being shown.

FIGS. 2b, 2c and 2d show variants of the sealing seat 10 between the pin part 2 and the sealing bellows 8, which differ from the exemplary embodiments according to FIGS. 1 and 2a in terms of the cross section of the components used. A common feature of all embodiment variants is that the sealing seat 10 comprises the sealing ring 11 with static contact with the pin part 2 and the annular sleeve 13, which is, in turn, statically firmly in contact with the sealing bellows 8.

Thus, FIG. 2b shows that the sealing ring 11 has an essentially rectangular shape here, and a sealing lip 17 projecting on the outer circumference is in contact with the inner side of the annular sleeve 13, and the partition line located between the two parts is responsible for the necessary sealing effect. The lock washer 14 recognizable in FIG. 2a is eliminated in the exemplary embodiment according to FIG. 2b, because the annular sleeve 13 and the sealing bellows 8 surrounding same are connected with one another in one piece by a vulcanization process.

The sealing ring 11 likewise has an essentially rectangular shape in the exemplary embodiment according to FIG. 2c. The sectional view shows, moreover, that a circular stiffening element 18, which may comprise, e.g., a circular metal ring, is located within the sealing ring 11. The annular sleeve 13 has an essentially S-shaped cross section in this exemplary embodiment. Moreover, this figure shows that a stiffening element 19 is likewise integrated in the sealing bellows 8.

The exemplary embodiment according to FIG. 2d corresponds essentially to that in FIG. 2b. However, it can be determined from the sectional view that a stiffening element 18 is arranged here within the sealing ring 11, analogously to FIG. 2c.

### LIST OF REFERENCE NUMBERS

1. Pivot pin

2. Pin part

3. Spherical surface

4. Joint shell

5. Joint housing

6. Area

7. Vehicle part

8. Sealing bellows

9. Lock washer

10. Sealing seat

11. Sealing ring

12. Shoulder

13. Annular sleeve

14. Lock washer

15. Partial area

16. Partial area

17. Sealing lip

18. Stiffening element

19. Stiffening element

1. Ball-and-socket joint, preferably for vehicle suspensions or steering mechanisms of motor vehicles, with a said joint housing (5), a said pivot pin (1), which comprises a said spherical surface (3) and a said pin part (2) and which is mounted rotatably and deflectably in the said joint housing (5) and is fixed with the said pin part (2) on a said mount (7) provided on the vehicle, and with a said elastic sealing bellows (8), which is fixed statically at the said joint housing (5) and at the said pin part (2) by means of at least one said sealing seat (10),
characterized in that
the said sealing seat (10) between the said sealing bellows (8) and the said pin part (2) has a said elastic sealing ring (11) that is directly in contact with the said pin part (2) under pretension or is connected in substance thereto and a said annular sleeve (13) arranged between the said sealing bellows (8) and the said sealing ring (11).

2. Ball-and-socket joint in accordance with claim 1,
characterized in that the said sealing ring (11) has a circular cross section in the preassembled state.

3. Ball-and-socket joint in accordance with claim 1,
characterized in that the said sealing ring (11) has an oval cross section.

4. Ball-and-socket joint in accordance with claim 1,
characterized in that the said sealing ring (8) [sic—Tr.Ed.] has a rectangular cross section.

5. Ball-and-socket joint in accordance with claim 1
characterized in that the sealing ring consists of an unvulcanized rubber material.

6. Ball-and-socket joint in accordance with claim 1,
characterized in that the said sealing ring (8) [sic—Tr.Ed.] consists of a plastic material, preferably PUR or PTFE.

7. Ball-and-socket joint in accordance with one of the claims 1 through 6,
characterized in that said stiffening elements (18) consisting of a non-elastic material, preferably metal, are arranged in the cross section of the said sealing ring (8) [sic—Tr.Ed.].

8. Ball-and-socket joint in accordance with one of the claims 1 through 7,
characterized in that the cross section of the said annular sleeve (13) has a said first partial area (15) extending in parallel to the surface of the said pin part (2) and a said second partial area (16) that is bent in relation thereto.

9. Ball-and-socket joint in accordance with one of the claims 1 through 8,
characterized in that the said annular sleeve (13) consists of special steel.

10. Ball-and-socket joint in accordance with one of the claims 1 through 8,
characterized in that the said annular sleeve (13) consists of plastic.

11. Ball-and-socket joint in accordance with one of the claims 1 through 10,
characterized in that the said annular sleeve (13) has an anticorrosion coating at least on its surface facing the said sealing ring (11).

12. Ball-and-socket joint in accordance with one of the claims 1 through 11,
characterized in that the said annular sleeve (13) has a sliding-improving coating at least on its surface facing the said sealing ring (11).

13. Ball-and-socket joint in accordance with one of the claims 1 through 12,
characterized in that the said annular sleeve (13) is made in one piece with the said sealing bellows (8).

14. Ball-and-socket joint in accordance with one of the claims 1 through 12,
characterized in that the said annular sleeve (13) arranged between the said sealing bellows (8) and the said sealing ring (11) is rigidly connected to the said sealing bellows (8).
